(19) United States
(12) Patent Application Publication
(10) Pub. No.: US 2020/0198937 A1
(43) Pub. Date: Jun. 25, 2020

(54) Mining crane which is convenient to install

(71) Applicant: Jin Lan, Guangzhou City (CN)

(72) Inventor: Jin Lan, Guangzhou City (CN)

(21) Appl. No.: 16/808,351

(22) Filed: Mar. 3, 2020

(30) Foreign Application Priority Data
Nov. 26, 2019 (CN) 2019111771104

(51) Int. Cl. B66C 5/04; B66C 13/14; B66C 9/14; B66C 23/16; B66C 23/18

(52) U.S. Cl. CPC B66C 5/04; B66C 13/14; B66C 23/18; B66C 23/16; B66C 9/14

(57) ABSTRACT

The invention discloses a mining crane which is easy to install, and includes a base which is symmetrical in front and back. A support column is fixed on the upper end surface of the base, and a fixed block is fixed on the upper end of the support column. The fixed block, the support column and A traveling device is arranged between the bases, and the traveling device includes four rotatable traveling wheels. When the traveling wheels rotate, the fixed block is moved, and a lifting device is provided in the fixed block. The heavy device includes a rewindable hook for lifting the heavy ore. The traveling device can drive the whole to adjust the installation position through the traveling device. The device has two installation and support methods that can directly abut the mine wall and drill into the mine wall. According to the actual situation of the mine and mining area, it can be reasonably selected to expand its scope of application, without being restricted by the region. Secondly, the support rod and telescopic rod can be contracted and rotated to reduce the overall volume of the present invention, which is convenient for movement and handling, and convenient for loading and unloading.

### CROSS-REFERENCES TO RELATED APPLICATIONS

The present application claims priority from Chinese application No. 2019111771104 filed on Sep. 19, 2019 which is hereby incorporated by reference in its entirety.

### TECHNICAL FIELD

The invention relates to the technical field of mining equipment, in particular to a mining crane which is convenient to install.

### BACKGROUND OF THE INVENTION

Crane refers to the moving lifting machinery that vertically lifts and transports heavy objects horizontally within a certain range, also known as crane, aerial crane, and crane. Cranes are usually installed or parked on flat roads to maintain balance and increase lifting capacity. Stability of work, but as a crane in mining work, because the environment for mining ore is basically on the edge of the mountain or between narrow rocks or mountains, the surface is uneven, the shape is different, it is difficult to install the crane, so for the deep mining and digging The use of other cargo lifting devices that are complicated in operation and not easy to move is often used to assist, and the environment in which the lifting devices are installed is strict. Most of them are suitable for use in deep and wide mines, which limits their use. The present invention illustrates a device capable of solving the above problems.

### BRIEF SUMMARY OF THE INVENTION

### Technical Problem

The existing mining cranes are difficult to install and maintain balance, there are hidden safety hazards, and due to their large size, their scope of application and area are limited.

In order to solve the above problems, this example designs a mining crane that is easy to install. The mining crane that is easy to install in this example includes a pedestal that is symmetrical in front and back, and a support post is fixed on the upper end surface of the pedestal. A fixed block is fixedly provided, and a traveling device is provided between the fixed block, the support column and the base. The traveling device includes four rotatable traveling wheels, and the traveling block drives the stationary block when it is rotated. Moving, the fixed block is provided with a lifting device, the lifting device includes a rewindable hook for lifting the ore heavy object, the fixed block is provided with a left-right symmetrical support rod, and the support rod is provided with the support rod. There is a rotating device. The rotating device includes a threaded cavity. A groove is provided on the upper side of the threaded cavity. A rack is fixed in the groove. A sliding groove is provided on the lower side of the threaded cavity. A spline shaft is provided for rotation, and a telescopic rod splined to the spline shaft is provided in the thread of the thread cavity, and a regulating device is arranged in the telescopic rod, and the regulating device includes a rotatable and a rack. Meshing rotating gear, so A plug block is slidably arranged on the lower side of the eighth bevel gear, and the lower end of the plug block can extend into the sliding groove. The spline shaft rotates to drive the telescopic rod to rotate and move. When the plug block is extended, When in the sliding groove, the rotating gear meshes with the rack, the rotation of the spline shaft drives the telescopic rod to move only, so that the rotating gear rotates, and the end of the telescopic rod away from the center of symmetry A support block is fixedly fixed, the support block is in contact with the wall to fix the position of the fixed block, and a support device is provided in the support block. The support device includes four rotatable drill bits, and the rotating gear rotates. It can provide power for the rotation of the drill bit, so that the drill bit is drilled into the wall, and the installation stability of the fixing block is improved.

Wherein, the travelling device includes a left-right symmetrical travelling slot, and a travelling wheel is rotatably provided in the travelling slot, the left and right travelling wheels are dynamically connected through a travel shaft, and the right end of the travelling wheel on the front side is dynamically connected to the travelling On the motor, the traveling motor is installed on the right end wall of the traveling groove at the right end position on the front side, and a belt cavity is provided in the fixed block, and a first pulley with front-rear symmetry is rotated in the belt cavity. The first pulleys are dynamically connected by a connecting belt. A second pulley is fixed on the right side of the first pulley. The second pulley and the traveling shaft which are vertically corresponding are dynamically connected through a synchronous belt. The traveling motor works, which drives the four traveling wheels to rotate synchronously, thereby moving the fixed block as a whole.

Wherein, the lifting device includes a winding chamber communicating with the outside, a winding motor is fixed on the right end wall of the winding chamber, and a winding motor connected to the left end wall of the winding chamber is installed at the left end of the winding motor. A reel, a reel is fixed on the reel, a wire rope is wound around the reel, and the hook is fixed on the lower end of the wire rope, so that the rewind motor controls the rewind of the hook.

Preferably, the fixing block is provided with a left-right symmetrical turning cavity, the support rod is rotatably installed in the turning cavity through a turning shaft, a front side of the turning cavity is provided with an engaging cavity, and a front end of the turning shaft extends A first bevel gear is fixed to the meshing cavity, a second bevel gear is meshedly connected to an end of the first bevel gear near the center of symmetry, and a power shaft is fixed at the center of the second bevel gear. A power motor is installed between the meshing chambers, and an end of the power shaft remote from the second bevel gear is dynamically connected to the power motor, so that the power motor can drive the support rod to rotate.

Wherein, the rotating device includes a slot, a third bevel gear is provided on the upper end wall of the slot through a gear shaft, and a transmission cavity is provided on a side of the slot near the sliding slot. A fourth bevel gear is rotatably provided on the transmission shaft, and the transmission shaft and the gear rotating shaft are dynamically connected by a transmission belt. An end of the fourth bevel gear near the sliding groove is meshed with a fifth bevel gear. A fifth bevel gear is fixedly installed at the center of the spline shaft, so that the rotation of the third bevel gear can drive the spline shaft to rotate.

Preferably, a driving motor is installed between the turning cavities, and symmetrical driving shafts are installed at the left and right ends of the driving motor. The other end of the driving shaft extends into the slot and is fixed with a sixth bevel gear. The sixth bevel gear is meshably connected with the third bevel gear, so that when the sixth bevel gear meshes with the third bevel gear, the driving motor works to provide power for the rotation device.

Wherein, the regulating device comprises a lifting groove with an opening upward, a lifting block is slidably arranged in the lifting groove, the rotating gear is rotatably installed in the lifting block through a rotating shaft, and a rotation is provided on the rear side of the lifting groove. A groove, a rear end of the rotation shaft extends into the rotation groove and a seventh bevel gear is fixed therein; an eighth bevel gear is provided in the rotation groove through a connecting shaft to rotate, and the eighth bevel gear and the first bevel gear Seven-bevel gears can be meshed and connected. A receiving groove is provided on the lower side of the rotating groove, and the plug-in block is slidably disposed in the receiving groove. Both the receiving groove and the front side of the lifting groove are provided with a regulating groove. A threaded shaft is provided for rotation in the control groove, and a control motor is installed between the threaded shafts. A connection block is threadedly connected to the threaded shaft, and the rear end of the connection block is respectively connected to the lifting block and the plug-in block. It is fixedly connected, so that the control motor drives the upper and lower connection blocks to move synchronously, so that the plug block is connected to the sliding groove, the rotating gear is engaged with the rack, and the spline is further caused. When the shaft rotates, the telescopic rod only moves horizontally Does not rotate.

Wherein, the supporting device includes a synchronization cavity, and the annular array in the synchronization cavity is provided with four rotatable spline rods, and a driven pulley is fixed on the spline rod, and between the driven pulleys Through the power connection of the linkage belt, one end of the connection shaft extending away from the fixed block into the synchronization cavity and a driving pulley is fixedly arranged, and the driving pulley passes through the driven pulley on the upper side. Rotate the belt for power connection. The side of the synchronization cavity away from the fixed block is provided with four thread grooves in the annular array. The drill bit is disposed in the thread groove. The spline rod extends into the thread groove and It is splined to the drill bit, so that the rotation of the connection shaft drives four of the drill bits to rotate and move, so that the drill bit is drilled into the wall.

The beneficial effect of the present invention is that the present invention can drive the whole to adjust the installation position through the traveling device, and has two installation and support methods that can directly contact the mine wall body and drill into the mine wall body. Reasonable choices are made in actual conditions to expand its scope of application, regardless of geographical restrictions. Secondly, the support rods and telescopic rods can be contracted and rotated to reduce the overall volume of the invention, which is convenient for movement and handling, and convenient for loading and unloading.

### BRIEF DESCRIPTION OF THE DRAWINGS

For ease of explanation, the present invention is described in detail by the following specific embodiments and the accompanying drawings.

FIG. 1 is a schematic diagram of the overall structure of a convenient installation mining crane of the present invention;

FIG. 2 is a schematic structural diagram of the direction “A-A” of FIG. 1; FIG.

[symbol]

FIG. 3 is a schematic structural diagram of the “B-B” direction of FIG. 2; FIG.

[symbol]

FIG. 4 is a schematic structural diagram of the “C-C” direction of FIG. 1; FIG.

[symbol]

FIG. 5 is an enlarged structural diagram of “D” of FIG. 1; FIG.

[symbol]

FIG. 6 is a schematic structural diagram of the “E-E” direction of FIG. 5.

### DETAILED DESCRIPTION OF THE INVENTION

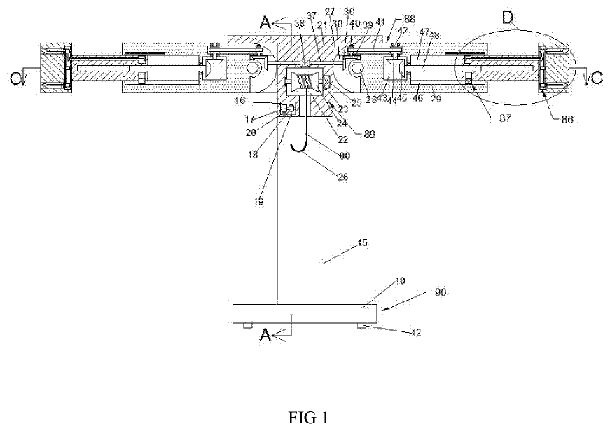

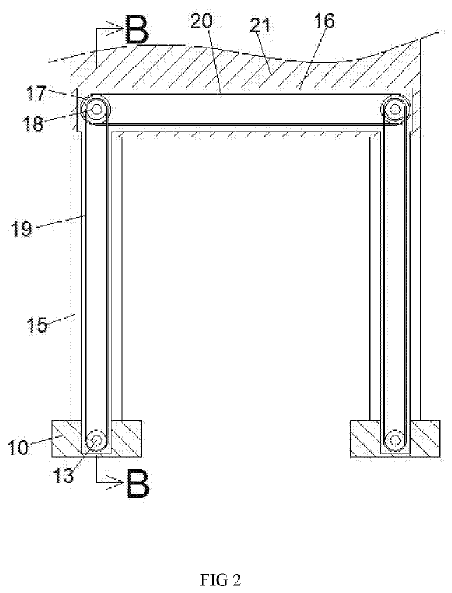

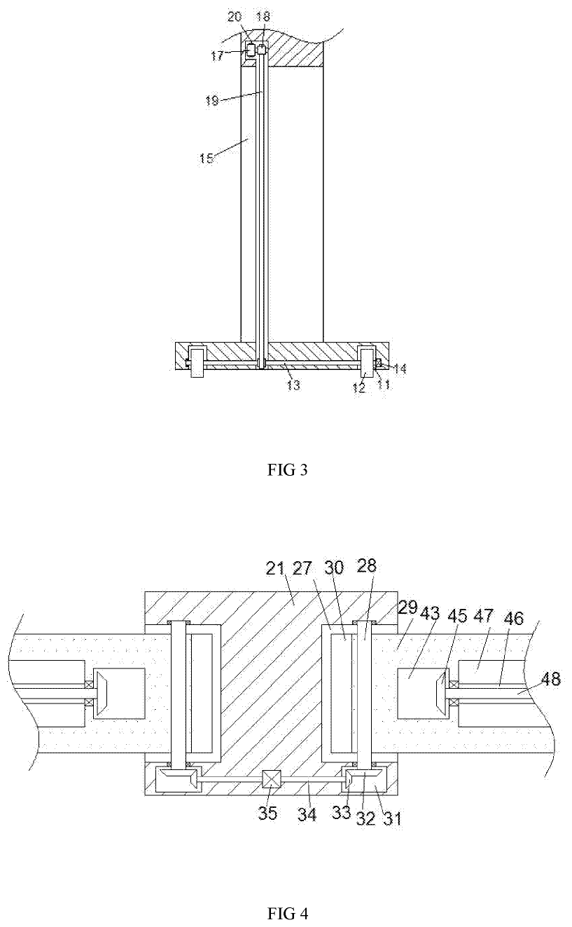

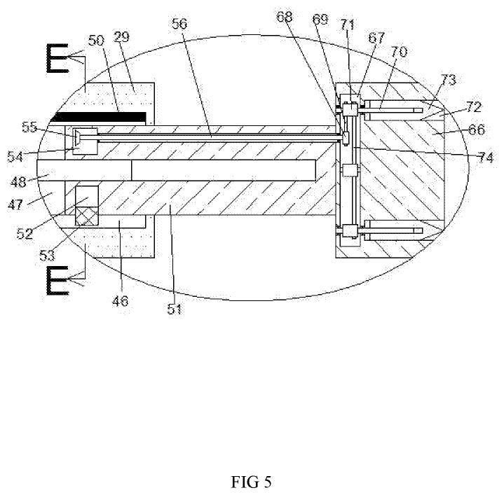

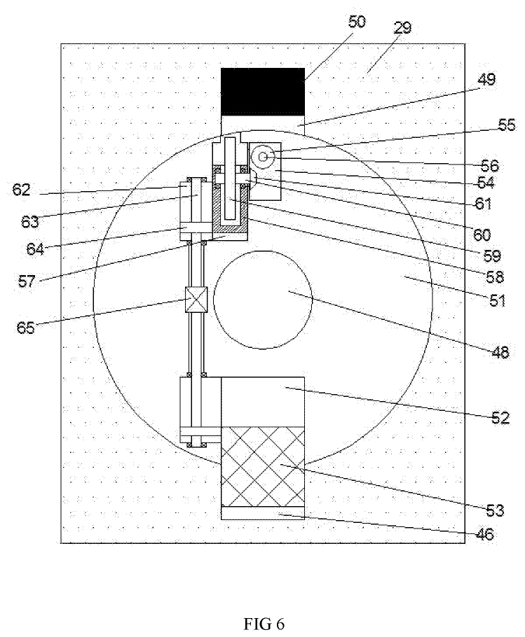

The present invention is described in detail below with reference to FIGS. 1 to 6. For convenience of description, the orientation described below is defined as follows: the up-down, left-right, front-back direction described below is consistent with the up-down, left-right, front-back direction of the projection relationship of FIG.

[symbol]

The present invention relates to an easy-to-install mining crane, which is mainly used for mining work. The present invention will be further described below with reference to the accompanying drawings of the present invention:

A convenient installation mining crane according to the present invention includes a front-rear symmetrical base 10, and a support column 15 is fixed on the upper end surface of the base 10, and a fixing block 21 is fixed on the upper end of the support column 15; 21. A traveling device 90 is provided between the support column 15 and the base 10. The traveling device 90 includes four rotatable traveling wheels 12. When the traveling wheel 12 rotates, the fixed block 21 moves, A lifting device 89 is provided in the fixing block 21, and the lifting device 89 includes a rewindable hook 26 for lifting the ore weight. The fixing block 21 is provided with a left-right symmetrical support rod 29. The support rod 29 is provided with a rotating device 88, which includes a threaded cavity 47. A groove 49 is provided on the upper side of the threaded cavity 47, and a rack 50 is fixed in the groove 49. The threaded cavity 47 is provided with a sliding groove 46 on the lower side, and a spline shaft 48 is rotatably provided in the threaded cavity 47. An internally threaded telescopic shaft 51 is provided with a telescopic rod 51 splined to the splined shaft 48. A regulating device 87 is provided in the lever 51, and the regulating device 87 includes a rotating gear rotatably engaged with the rack 50. 59. The eighth bevel gear 55 is provided with a plug-in block 53 on the lower side. The lower end of the plug-in block 53 can extend into the slide groove 46. The spline shaft 48 rotates to drive the telescopic rod 51 to rotate. And move, when the plug block 53 extends into the sliding groove 46, the rotating gear 59 meshes with the rack 50, then the spline shaft 48 rotates to drive the telescopic rod 51 to move only, The rotation gear 59 is rotated, and a support block 66 is fixed at an end of the telescopic rod 51 far from the center of symmetry. The support block 66 abuts against a wall to fix the position of the fixing block 21 in the support block 66. A supporting device 86 is provided, and the supporting device 86 includes four rotatable drill bits 73. The rotation of the rotation gear 59 can provide power for the rotation of the drill bit 73, so that the drill bit 73 is drilled into the wall to improve the Mounting stability of the fixing block 21.

According to the embodiment, the travel device 90 will be described in detail below. The travel device 90 includes a left-right symmetric travel slot 11. A travel wheel 12 is rotatably provided in the travel slot 11, and travel is performed between the left and right travel wheels 12. The shaft 13 is power-connected, and the right end of the travel wheel 12 on the front side is power-connected to a travel motor 14 that is mounted on the right end wall of the travel slot 11 at the right end position on the front side, inside the fixing block 21 A belt cavity 16 is provided, and the first and second symmetrical pulleys 17 are rotatably provided in the belt cavity 16. The first pulleys 17 are dynamically connected by a connecting belt 20. Two pulleys 18, the second pulley 18 and the traveling shaft 13 which are vertically corresponding are dynamically connected through a synchronous belt 19, so that the traveling motor 14 works, driving the four traveling wheels 12 to rotate synchronously, thereby fixing The block 21 moves as a whole.

According to the embodiment, the lifting device 89 is described in detail below. The lifting device 89 includes a winding chamber 22 communicated with the outside world. A winding motor 25 is fixed on the right end wall of the winding chamber 22, and the winding A winding shaft 23 rotatably connected to the left end wall of the winding chamber 22 is installed at the left end of the motor 25. A winding wheel 24 is fixed on the winding shaft 23, and a wire rope 80 is wound around the winding wheel 24. The hook 26 is fixed at the lower end of the wire rope 80, so that the winding motor 25 works to control the winding of the hook 26.

Advantageously, the fixing block 21 is provided with a left-right symmetrical turning cavity 27, the supporting rod 29 is rotatably installed in the turning cavity 27 through a turning shaft 28, and a front side of the turning cavity 27 is provided with an engagement cavity 31, The front end of the turning shaft 28 extends into the meshing cavity 31 and is fixed with a first bevel gear 32. A second bevel gear 33 is meshed with an end of the first bevel gear 32 near the center of symmetry, and the second bevel A power shaft 34 is fixed at the center of the gear 33, and a power motor 35 is installed between the meshing chambers 31. An end of the power shaft 34 remote from the second bevel gear 33 is dynamically connected to the power motor 35, so that The operation of the power motor 35 can drive the support rod 29 to rotate.

According to the embodiment, the rotating device 88 is described in detail below. The rotating device 88 includes a slot 30, and an upper end wall of the slot 30 is rotated by a gear rotating shaft 40 to be provided with a third bevel gear 39. A transmission cavity 43 is provided on one side of the sliding groove 46, and a fourth bevel gear 44 is rotatably provided in the transmission cavity 43 through a transmission shaft 42. The transmission shaft 42 and the gear rotation shaft 40 are driven by a transmission belt 41 Connection, a fifth bevel gear 45 is meshingly connected to one end of the fourth bevel gear 44 near the sliding groove 46, and the fifth bevel gear 45 is fixedly installed at the center of the spline shaft 48, so that the third Rotation of the bevel gear 39 drives the spline shaft 48 to rotate.

Beneficially, a driving motor 38 is installed between the turning chambers 27, and symmetrical driving shafts 37 are installed at the left and right ends of the driving motor 38. The other ends of the driving shafts 37 extend into the slot 30 and are fixed. There is a sixth bevel gear 36, and the sixth bevel gear 36 is meshably connected with the third bevel gear 39, so that when the sixth bevel gear 36 is meshed with the third bevel gear 39, the driving motor 38 The operation provides power for the operation of the rotating device 88.

According to the embodiment, the regulating device 87 will be described in detail below. The regulating device 87 includes a lifting groove 57 with an opening facing upward. A lifting block 58 is slidably arranged in the lifting groove 57. The rotating gear 59 rotates through a rotating shaft 60. Mounted in the lifting block 58, a rotating groove 54 is provided on the rear side of the lifting groove 57, a rear end of the rotating shaft 60 extends into the rotating groove 54 and a seventh bevel gear 61 is fixed, and the rotation An eighth bevel gear 55 is rotatably provided in the groove 54 through a connecting shaft 56, and the eighth bevel gear 55 is meshably connected with the seventh bevel gear 61. A receiving groove 52 is provided on the lower side of the rotation groove 54. The plug-in block 53 is slidably disposed in the receiving groove 52, and both the receiving groove 52 and the lifting groove 57 are provided with a regulating groove 62 on the front side, and a screw shaft 63 is rotated in the regulating groove 62. A regulating motor 65 is installed between the shafts 63. A connection block 64 is screw-connected to the threaded shaft 63. The rear end of the connection block 64 is fixedly connected to the lifting block 58 and the plug-in block 53, respectively. The control motor 65 drives the upper and lower connection blocks 64 to move synchronously, so that the plug-in block 53 and the connection block 64 move synchronously. Insertion groove 46, the rotation of the ring gear 50 with the rack 59, and further such that the spline shaft 48 is rotated, only horizontal movement of the telescopic rod 51 is not rotated.

According to the embodiment, the supporting device 86 will be described in detail below. The supporting device 86 includes a synchronization cavity 67. The annular array in the synchronization cavity 67 is provided with four rotatable spline rods 70. A driven pulley 71 is fixedly connected, and the driven pulleys 71 are dynamically connected through a linkage belt 74. One end of the connection shaft 56 extending away from the fixing block 21 into the synchronization cavity 67 is fixedly provided. A driving pulley 68 is dynamically connected to the driven pulley 71 and the driven pulley 71 on the upper side through a rotating belt 69. A ring array on a side of the synchronization cavity 67 remote from the fixing block 21 is provided with four Thread grooves 72, the drill bit 73 is disposed in the thread groove 72, the spline rod 70 extends into the thread groove 72 and is splined to the drill bit 73, so that the connection shaft 56 is driven by rotation The four drill bits 73 are rotated and moved, so that the drill bits 73 are drilled into the wall.

The following describes in detail the use steps of an easy-to-install mining crane in this article with reference to FIGS. 1 to 6:

Initially, the upper end of the hook 26 abuts the lower end surface of the fixed block 21, the support rod 29 is placed vertically, the sixth bevel gear 36 is disengaged from the third bevel gear 39, the telescopic rod 51 is contracted in the thread cavity 47, and the drill bit 73 It is contracted in the screw groove 72, the plug block 53 is contracted in the receiving groove 52, the rotation gear 59 is contracted in the lifting groove 57, and the seventh bevel gear 61 and the eighth bevel gear 55 are not meshed.

When moving, the traveling motor 14 is started, and the traveling wheel 12 is driven to rotate, so that the base 10, the supporting column 15 and the fixing block 21 are moved to the required installation position as a whole;

During installation, the power motor 35 is started to rotate the power shaft 34, and the first bevel gear 32 drives the reversing shaft 28 to rotate, so that the support rod 29 is rotated to a horizontal state. At this time, the sixth bevel gear 36 meshes with the third bevel gear 39 After that, the driving motor 38 starts to work, and drives the sixth bevel gear 36 to rotate, the third bevel gear 39 rotates, and the fourth bevel gear 44 is driven to rotate through the transmission belt 41, and then the spline shaft 48 rotates, and in the thread cavity 47 With the cooperation, the telescopic rod 51 is rotated and moved away from the fixed block 21, so that the support block 66 is closely fitted to the wall of the mine body, and then the fixed block 21 is installed;

If the wall of the mine is uneven, and the fixed block 21 cannot be installed stably by the abutment of the support block 66, the control motor 65 is started to rotate the screw shaft 63, the upper and lower connection blocks 64 are moved back, and the lifting block 58 is moved upward. So that the rotating gear 59 can mesh with the rack 50, the seventh bevel gear 61 meshes with the eighth bevel gear 55, the plug block 53 descends and extends to the sliding groove 46, and when the spline shaft 48 rotates, the telescopic rod 51 does not rotate Move only in a direction away from the fixed block 21. When the rotation gear 59 meshes with the rack 50, the rotation of the rotation gear 59 will be driven by the movement of the telescopic rod 51, and the eighth bevel gear 55 will rotate. The wheel 68 rotates, and the four drill bits 73 are rotated and moved away from the connecting shaft 56 by the transmission of the rotation belt 69 and the linkage belt 74, and the drill bit 73 is drilled into the mine, so that the fixing block 21 is installed stably;

When working, start the winding motor 25 to make the winding wheel 24 rotate, the wire rope 80 is loosened and the hook 26 is lowered to attach the heavy ore. When the winding motor 25 works in reverse, the winding wheel 24 is reversed, and the wire rope 80 is retracted Roll up and lift the weight.

The beneficial effect of the present invention is that the present invention can drive the whole to adjust the installation position through the traveling device, and has two installation and support methods that can directly contact the mine wall body and drill into the mine wall body. Reasonable choices are made in actual conditions to expand its scope of application, regardless of geographical restrictions. Secondly, the support rods and telescopic rods can be contracted and rotated to reduce the overall volume of the invention, which is convenient for movement and handling, and convenient for loading and unloading.

In the above manner, those skilled in the art can make various changes according to the working mode within the scope of the present invention.

1. An easy-to-install mining crane includes a symmetric back-and-forth base, characterized in that a support pillar is fixed on the upper end surface of the base;
A fixed block is fixed at the upper end of the support column, and a traveling device is provided between the fixed block, the support column and the base. The traveling device includes four rotatable traveling wheels. When the traveling wheel rotates, Drive the fixed block to move, a lifting device is provided in the fixed block, the lifting device includes a rewindable hook for lifting heavy ore;
A left-right symmetrical support rod is provided in the fixed block, and a rotation device is provided in the support rod. The rotation device includes a threaded cavity, and a groove is provided on the upper side of the threaded cavity. A rack is provided with a sliding groove on the lower side of the threaded cavity, and a spline shaft is rotatably provided in the threaded cavity. A telescopic rod splined to the spline shaft is provided in the thread of the threaded cavity. There is a regulating device inside the rod, the regulating device includes a rotating gear that can be rotated to mesh with the rack, a plug block is slidably arranged on the lower side of the eighth bevel gear, and the lower end of the plug block can extend to the In the sliding groove, the spline shaft rotates to drive the telescopic rod to rotate and move. When the plug block extends into the sliding groove, the rotating gear meshes with the rack, then the spline The rotation of the shaft drives the telescopic rod to move only, so that the rotating gear rotates;
A support block is fixed at an end of the telescopic rod far from the center of symmetry, and the support block abuts a wall to fix the position of the fixed block. A support device is provided in the support block, and the support device includes four For a rotating drill, the rotation of the rotating gear can provide power for the rotation of the drill, so that the drill is drilled into the wall, and the installation stability of the fixed block is improved.

2. The easy-to-install mining crane according to claim 1, wherein the traveling device includes a left-right symmetrical traveling groove;
A traveling wheel is provided for rotation in the traveling groove, and the left and right traveling wheels are dynamically connected through a traveling shaft. The right end of the traveling wheel on the front side is dynamically connected to a traveling motor, and the traveling motor is installed on the front side and is located at the right end. On the right end wall of the traveling groove at the position, a belt cavity is provided in the fixed block, and a first pulley symmetrical in front and rear is rotated in the belt cavity, and the first pulleys are dynamically connected by a connecting belt. A second belt pulley is fixed on the right side of the first belt pulley, and the second belt pulley and the traveling shaft that are vertically corresponding are connected by a synchronous belt power.

3. The easy-to-install mining crane according to claim 1, wherein the lifting device comprises a winding chamber communicating with the outside world;
A winding motor is fixed on the right end wall of the winding chamber, and a winding shaft that is rotatably connected to the left end wall of the winding chamber is installed at the left end of the winding motor. A winding wheel is fixed on the winding shaft. A wire rope is wound around the reel, and the hook is fixed at the lower end of the wire rope.

4. The mining crane according to claim 1, wherein the fixed block is provided with a left-right symmetrical turning cavity;
The support rod is rotatably installed in the turning cavity through a turning shaft, a meshing cavity is provided on a front side of the turning cavity, a front end of the turning shaft extends into the meshing cavity and a first bevel gear is fixed, A second bevel gear is meshedly connected to an end of the first bevel gear near the center of symmetry, and a power shaft is fixed at the center of the second bevel gear. A power motor is installed between the meshing cavities, and the power shaft is far away from the first bevel gear. One end of the two-bevel gear is dynamically connected with the power motor.

5. The easy-to-install mining crane according to claim 1, wherein the rotating device comprises a slot;
A third bevel gear is provided on the upper end wall of the slot through a gear rotation shaft, and a transmission cavity is provided on a side of the slot near the sliding slot, and the fourth bevel gear of the roommate is rotated by the transmission shaft in the transmission cavity. A power transmission belt is connected between the transmission shaft and the gear rotating shaft. A fifth bevel gear is meshed with one end of the fourth bevel gear near the sliding groove. The center of the fifth bevel gear is connected with the flower. The key shaft is fixedly installed.

6. The mining crane according to claim 5, wherein a driving motor is installed between the turning cavities, symmetrical driving shafts are installed at the left and right ends of the driving motor, and the other end of the driving shaft is A sixth bevel gear is extended into the slot and is fixedly connected with the third bevel gear.

7. The easy-to-install mining crane according to claim 1, wherein the regulating device comprises a lifting groove with an opening facing upward;
A lifting block is slidably arranged in the lifting slot, the rotating gear is rotatably installed in the lifting block through a rotating shaft, a rotating slot is provided at the rear side of the lifting slot, and the rear end of the rotating shaft extends to the rotating slot. A seventh bevel gear is fixedly arranged inside, and an eighth bevel gear is provided in the rotation groove through a connecting shaft to rotate. The eighth bevel gear is meshably connected with the seventh bevel gear, and a lower side of the rotation groove is provided. There is a receiving slot, and the plug block is slidably disposed in the receiving slot. Both the receiving slot and the front side of the lifting slot are provided with a regulating slot, and a screw shaft is rotated in the regulating slot, and the screw shaft A regulating motor is installed between the screw shafts, and a connection block is screw-connected to the threaded shaft. The rear end of the connection block is fixedly connected to the lifting block and the plug-in block, respectively.

8. The easy-to-install mining crane according to claim 1, wherein the supporting device comprises a synchronization cavity;
the circular array in the synchronization cavity is provided with four rotatable spline rods. The spline rods are fixedly provided with driven pulleys, and the driven pulleys are dynamically connected through a linkage belt. The connection shaft An end remote from the fixed block extends into the synchronization cavity and a driving pulley is fixed, and the driving pulley and the driven pulley on the upper side are connected by a rotating belt power, and the synchronization cavity is away from Four annular grooves are provided on one side of the annular block of the fixed block, the drill bit is disposed in the thread groove, and the spline rod extends into the thread groove and is splined to the drill bit.
